(19) United States
(12) Patent Application Publication
(10) Pub. No.: US 2010/0097932 A1
(43) Pub. Date: Apr. 22, 2010

(54) SATELLITE TRAFFIC AND CONGESTION-BASED UPSTREAM SCHEDULER

(75) Inventor: Xiao Wu, Temecula, CA (US)

Correspondence Address: TOWNSEND AND TOWNSEND AND CREW LLP;VIASAT, INC. (CLIENT #017018), TWO EMBARCADERO CENTER, 8TH FLOOR, SAN FRANCISCO, CA, 94111, US

(73) Assignee: ViaSat, Inc., Carlsbad, CA (US)

(21) Appl. No.: 12/580,088

(22) Filed: Oct. 15, 2009

Related U.S. Application Data
(60) Provisional application No. 61/105,596, filed on Oct. 15, 2008.

(51) Int. Cl. H04L 1/00; H04B 7/185

(52) U.S. Cl. 370/235; 370/316

(57) ABSTRACT

Systems and methods for implementing a traffic and congestion-based scheduler. The method includes receiving a bandwidth request. The method further includes analyzing the application type to determine which of a plurality of schedulers is best equipped to efficiently service the bandwidth request based on the application type, analyzing network traffic patterns of the client to determine which of the plurality of schedulers is best equipped to efficiently service the bandwidth request based on the network traffic patterns of the client, and analyzing congestion of the satellite link to determine which of the plurality of schedulers is best equipped to efficiently service the bandwidth request based on the congestion of the satellite link. Further, the method includes, based on the analysis of the application type, the network traffic patterns of the client, and the congestion of the satellite, selecting a scheduler, and sending the bandwidth request to the selected scheduler.

### PRIORITY CLAIM

This application claims priority to U.S. Provisional Application No. 61/105,596, entitled SATELLITE TRAFFIC AND CONGESTION BASED UPSTREAM SCHEDULER, filed on Oct. 15, 2008, which is incorporated by reference in its entirety for any and all purposes.

### FIELD OF THE INVENTION

The present invention relates, in general, to satellite communications and, more particularly, to a satellite traffic and congestion-based upstream scheduler.

### BACKGROUND

In a satellite network upstream packet scheduler, design typically takes into account both the user experience and the channel capacity. A congestion-based random access method results in poor channel capacity utilization; while, with noncongestion-based methods, the terminal usually makes the bandwidth request to the central controller (i.e., to a satellite modem termination system (SMTS)) and receives noncongestion-based slots for transmission. The handshake interval is the round trip time (RTT) between the terminal and the central controller. The terminal will then transmit the packet and, ignoring the transmit time, the packet will arrive at the central controller one and one half RTTs later.

This process implies that all packets arriving to an empty output queue will experience a delay of 1.5xRTT, not counting the congestion delay, as its irreducible lower bound. For geosynchronous satellites where the RTT is typically around 500 ms, this kind of delay is intolerable for the performance of some responsive traffic. Therefore, various designs attempt to solve this problem caused by a demand-based scheduler (e.g., demand-assigned multiple access (DAMA)). In most cases, the new designs will allow the central controllers to assign bandwidth beyond what is requested by the terminal, resulting in a smaller delay experienced by the subsequent packets. These are speculation-based schedulers, as the central controller attempts to predict the bandwidth needs of the terminal.

One example of such a design is the enhanced mobile satellite services (EMSS), a 5-states predictive scheduler, as shown in FIG. 1. The issue with the speculation-based schedulers is that there is no guarantee that the traffic arrival can be perfectly predicted. There are many user behavior levels, protocol levels, hardware levels, and software levels of uncertainties that could make the prediction incorrect. As a result, the speculation-based schedulers typically result in much lower capacity utilization compared to the demand-based schedulers.

Generally in a satellite network, one of the two types of schedulers is used for scheduling satellite grants, and that scheduler continues to be used regardless of the type of traffic, the behavior of the traffic, or the congestion of the link. Accordingly, when a channel is not congested, a demand-based scheduler may be in use while a speculation-based scheduler would be more effective in lowering the packet delay without much penalty, because there are unused capacities in the network. Similarly, when a channel is congested, a speculation-based scheduler would assign bandwidth for transfer of a non-existing packet to one terminal while the real packets in another terminal suffer unnecessarily, thus adding additional delay. Therefore, bandwidth and network resources are wasted and the advantages of the two different types of schedulers are not realized. Hence, improvements in the art are needed.

### BRIEF SUMMARY

Embodiments of the present invention are directed to a system for implementing a traffic and/or congestion-based upstream scheduler over a satellite link. The system includes a client configured to transmit a bandwidth request, a satellite in communication with the client, and an access point which includes a scheduler allocator and a plurality of schedulers. The access point is in communication with the client via the satellite. The access point is configured to receive the bandwidth request from the client. The bandwidth request includes an associated application type. The scheduler allocator is configured to analyze the application type to determine which of a plurality of schedulers is best equipped to efficiently service the bandwidth request based on the application type, analyzing network traffic patterns of the client to determine which of the plurality of schedulers is best equipped to efficiently service the bandwidth request based on the network traffic patterns of the client, and analyzing congestion of the satellite link to determine which of the plurality of schedulers is best equipped to efficiently service the bandwidth request based on the congestion of the satellite link. The scheduler allocator is further configured to select, based on the analysis of the application type, the network traffic patterns of the client, and the congestion of the satellite link, one of the plurality of schedulers, and send the bandwidth request to the selected scheduler.

Another embodiment is directed to a method of implementing a traffic and/or congestion-based upstream scheduler over a satellite link. The method includes receiving, at an access point, a bandwidth request from a client, wherein the bandwidth request includes an associated application type. The method further includes analyzing, at a scheduler allocator within the access point, the application type to determine which of a plurality of schedulers is best equipped to efficiently service the bandwidth request based on the application type, analyzing, at the scheduler allocator, network traffic patterns of the client to determine which of the plurality of schedulers is best equipped to efficiently service the bandwidth request based on the network traffic patterns of the client, and analyzing, at the scheduler allocator, congestion of the satellite link to determine which of the plurality of schedulers is best equipped to efficiently service the bandwidth request based on the congestion of the satellite link. Further, the method includes, based on the analysis of the application type, the network traffic patterns of the client, and the congestion of the satellite link, selecting, at the scheduler allocator, one of the plurality of schedulers, and sending the bandwidth request to the selected scheduler.

In an alternative embodiment, a machine-readable medium is described. The machine-readable medium includes instructions for implementing a traffic and/or congestion-based upstream scheduler over a satellite link. The machine-readable medium includes instructions for receiving, at an access point, a bandwidth request from a client, wherein the bandwidth request includes an associated application type. The machine-readable medium further includes instructions for analyzing, at a scheduler allocator within the access point, the application type to determine which of a plurality of schedulers is best equipped to efficiently service the bandwidth request based on the application type, analyzing, at the scheduler allocator, network traffic patterns of the client to determine which of the plurality of schedulers is best equipped to efficiently service the bandwidth request based on the network traffic patterns of the client, and analyzing, at the scheduler allocator, congestion of the satellite link to determine which of the plurality of schedulers is best equipped to efficiently service the bandwidth request based on the congestion of the satellite link. Further, the machine-readable medium includes instructions for selecting, at the scheduler allocator, based on the analysis of the application type, the network traffic patterns of the client, and the congestion of the satellite link, one of the plurality of schedulers, and sending the bandwidth request to the selected scheduler.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a block diagram illustrating one example of an enhanced mobile satellite services (EMSS), 5-states predictive scheduler.

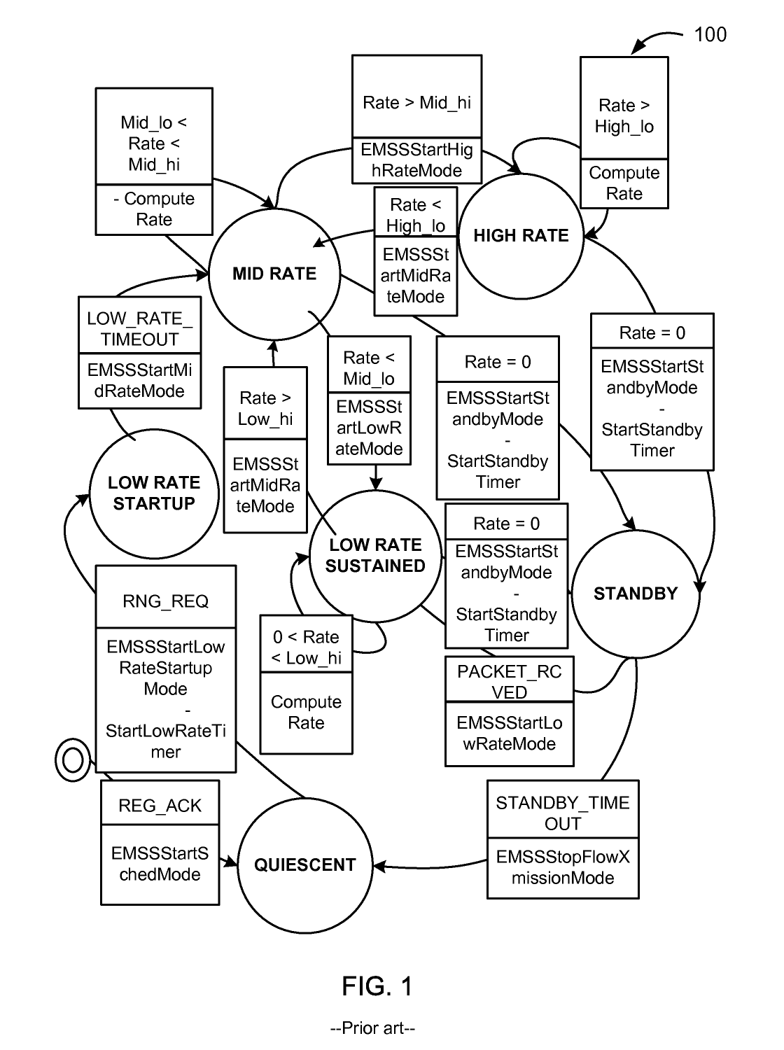

FIG. 2 is a block diagram illustrating a satellite communications system, which can be used in accordance with various embodiments of the invention.

FIG. 3 is a block diagram illustrating an SMTS which can be used in accordance with various embodiments of the invention.

FIG. 4 is a flow diagram illustrating a method of a satellite traffic and congestion-based upstream scheduler, according to one embodiment of the present invention.

FIG. 5 is a generalized schematic diagram illustrating a computer system, in accordance with various embodiments of the invention.

FIG. 6 is a block diagram illustrating a networked system of computers, which can be used in accordance with various embodiments of the invention.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It should be understood that various changes may be made in the function and arrangement of elements without departing from the spirit and scope of the invention as set forth in the appended claims.

Aspects of the disclosure relate to dynamically selecting a scheduler best suited to handle bandwidth requests for a given client or group of clients. The selection of the scheduler may be based in part on the application type of the requested content, the network usage patterns of the client or clients, and the congestion of the satellite link. Based on these factors, the most optimal scheduler is then selected to process the bandwidth request(s).

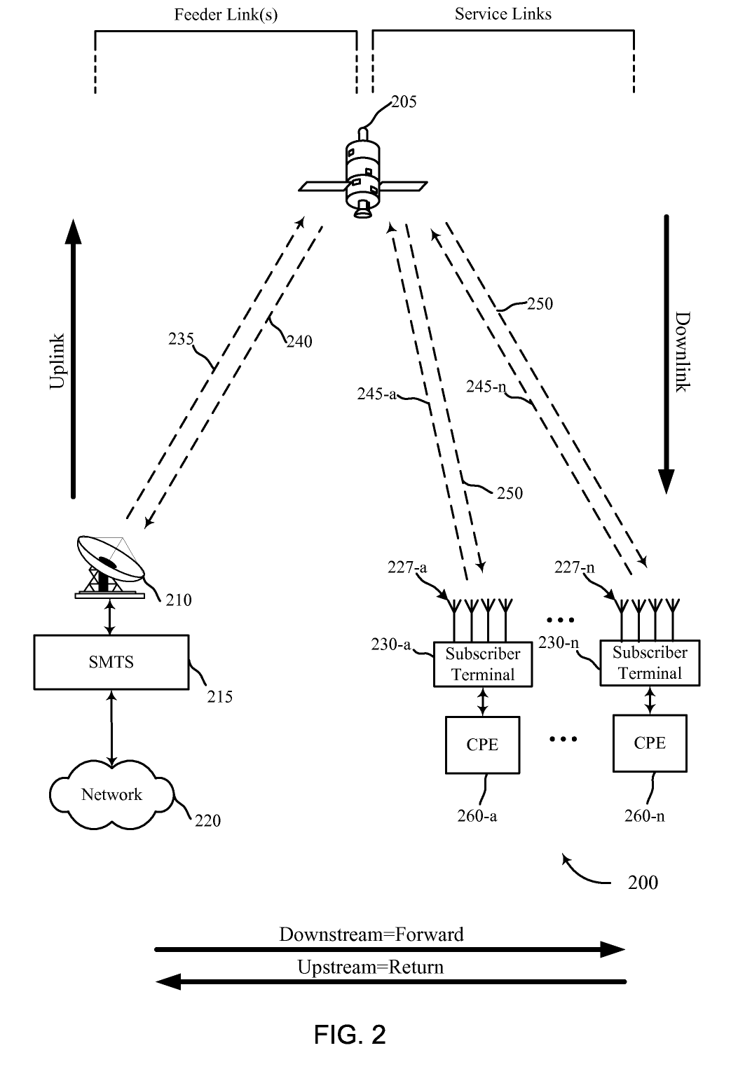

Embodiments of the present disclosure may be used within a satellite system, for example, like the satellite system shown in FIG. 2. In some embodiments, Satellite Modem Termination System (SMTS) 215 is coupled with a network 220, for example, the Internet. SMTS 215 uses a satellite dish 210 to bi-directionally communicate with satellite 205 on a feeder link. An upstream forward link 235 communicates information from SMTS 215 to satellite 205, and a downstream return link 240 communicates information from satellite 205 to SMTS 215. Although not shown, there may be a number of SMTSs 215 in the system 200.

In some embodiments, satellite 205 could perform switching or be a bent-pipe. Information bi-directionally passes through the satellite 205. Satellite 205 could use antennas or phased arrays when communicating. The communication could be focused into spot beams or more broadly cover a bigger geographical area, for example, the entire continental U.S. (CONUS). Satellites 205 have trouble reaching subscriber terminals 230 through foliage or other obstructions. At certain frequencies, even weather and other atmospheric disturbances can cause a satellite signal to fade.

Subscriber terminals 230 in some embodiments may be bi-directionally coupled with satellite 205 to provide connectivity with network 220. Each subscriber terminal 230 can receive information with a shared forward downlink 250 from satellite 205, and transmitted information may be sent on a number of return uplinks 245. Each subscriber terminal 230 can initiate a return uplink 245 to send information upstream to the satellite 205 and ultimately to the SMTS 215.

In some embodiments satellite system 200 may include multiple antennas on subscriber terminal 230. In some embodiments, subscriber terminal 230 can be in a fixed location or mobile. In some embodiments, subscriber terminal 230 may interact with a single transceiver in satellite 205. In other embodiments, subscriber terminal 230 may interact with multiple transceivers that may be orbitally-located or non-orbitable (e.g., air, ground or sea-based). Some embodiments of subscriber terminal 230 allow switching between these modes.

In some embodiments, multiple subscriber terminal 230 may request information from network 220 through SMTS 215 and satellite 205. Uplink bandwidth may be assigned to each subscriber terminal based on requests from the various subscriber terminals using, for example, a scheduler providing demand-assigned multiple access (DAMA) or Enhanced Mobile Satellite Services (EMSS) or other scheduling techniques. That is, in some embodiments, data may be transmitted from SMTS 215 through satellite 205 to one of the subscriber terminals 230 using bandwidth requested from the subscriber terminal 230 and allocated by a scheduler at SMTS 215. Once allocated, the bandwidth may not be used to communicate with another subscriber terminal. When the bandwidth has been used and the bandwidth allocation has been used to transmit the requested data, the bandwidth is de-allocated from the subscriber terminal 230.

Various schedulers and/or scheduler techniques may provide scheduling based on any of number of techniques. Many schedulers and/or scheduling techniques are known in the art and may be used to schedule and/or allocate bandwidth. Hence, different schedulers may be optimized for different tasks. For example, DAMA scheduling may be optimized for scheduling networks with congested channels, non-responsive traffic, and/or bursty traffic. EMSS scheduling, for example, may be good for networks with less congested channels, responsive traffic and periodic traffic. EMSS, for example, is good for Web traffic because Web traffic is really interactive (responsiveness). Often scheduler designs are left to make trade-offs between efficiency and responsiveness.

In some embodiments, an allocator is provided along with at least two schedulers. The allocator may analyze a request and assign a scheduler to the traffic based on the request type and/or the upstream data type. Such an allocator may allow an SMTS, for example, to provide both efficient and responsive scheduling by scheduling traffic through the appropriate scheduler. In some embodiments, the allocator may consider network congestion as a first criterion for sending a bandwidth request to one of two schedulers. After congestion, for example, the allocator may base its decision on whether the traffic is interactive and then on whether the traffic is periodic. If the traffic is congested, for example, a DAMA scheduler should be used. If the traffic is not congested, but is interactive, then an EMSS scheduler may be used. Other factors may also be considered beyond congestion, interactivity and/or periodicity.

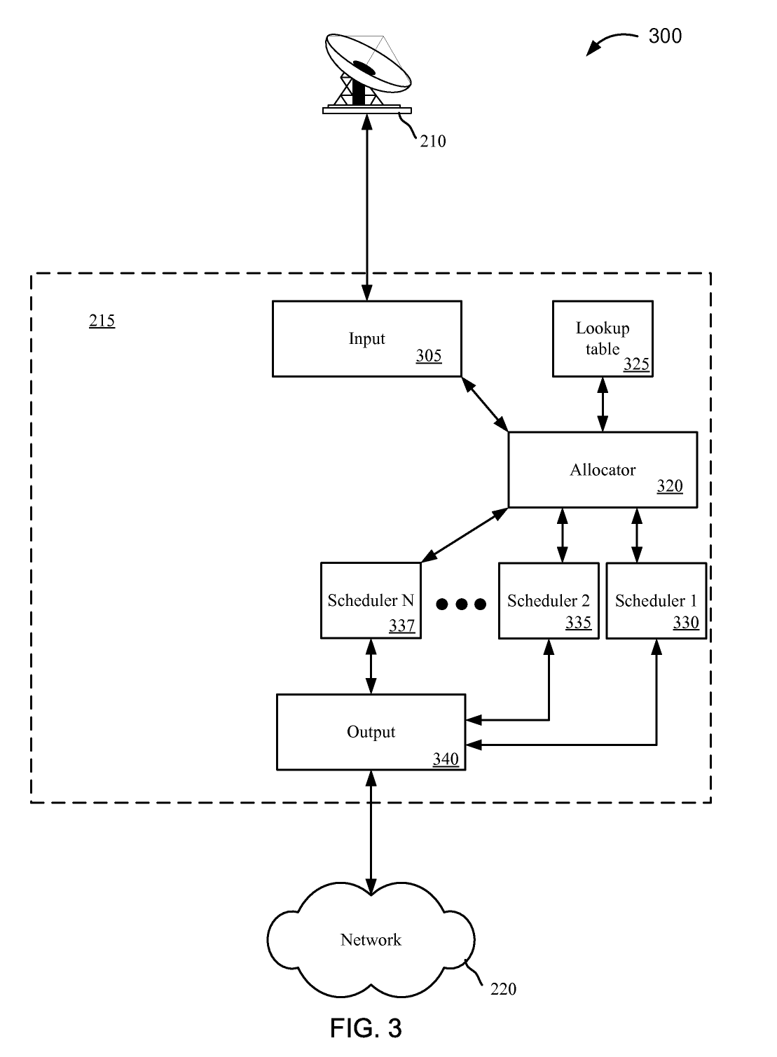

FIG. 3 shows an example of a block diagram of portions of an SMTS 215 according to one embodiment. SMTS 215 includes input 305 that receives a bandwidth request from antenna 210. Bandwidth requests may be sent to allocator 320 from input 305. Allocator 305 may send the bandwidth request to any one of scheduler 1 330, scheduler 2 335, or scheduler N 337, etc., based on any number of factors.

The factors may include the application type associated with the bandwidth request, the congestion of the satellite link, the network traffic patterns of the client requesting the bandwidth, etc. These factors may be placed within lookup table 325. The allocator 305, therefore, may receive a bandwidth request and use the lookup table 325 to determine which scheduler to send the bandwidth request. Furthermore, the factors may include whether the bandwidth request is for a VPN, VOIP, chatting, instant messaging, web browsing, FTP, streaming video, streaming audio, file downloads, encrypted data, etc. The factors may also include the ip address of the subscriber terminal making the request, the ip address of the data source, etc. The factors may also depend on network congestion, bandwidth availability, bandwidth utilization, etc.

In some embodiments, each scheduler may have a bandwidth request queue. Allocator 320 may place bandwidth requests in either queue depending on the type of request. Each scheduler may request data from network 220 through output 340 based on the results of the scheduler. In some embodiments, data from network 220 through SMTS 215 may be transmitted to the subscriber terminal based on the bandwidth allocated by the scheduler. In some embodiments, one of the schedulers is a default scheduler. In other embodiments, more than two schedulers are used, and so forth.

According to another embodiment, an allocator may monitor user traffic patterns. Based on the traffic patterns, the allocator may determine whether a periodic or best-effort scheduler would fit the traffic pattern better. The allocator may dynamically assign user service flow onto either type of the scheduler.

According to another embodiment, the allocator may monitor the overall traffic congestion. When the channel is not congested, user service may flow to a low efficiency/high responsiveness scheduler. When the channel is not congested, user service may flow to a high efficiency/low responsiveness scheduler.

In another embodiment, a subscriber terminal may request a specific scheduler and/or a specific scheduler type. Once the bandwidth request is received at the SMTS, the bandwidth request is sent to the requested scheduler. In another embodiment, a subscriber terminal may request a specific scheduler and/or scheduler type. At the SMTS, the allocator may grant the request or override the request based on any number of network factors. In yet another embodiment, traffic to a number of subscriber terminals may be transferred from one scheduler to another scheduler based on any of a number of factors, for example, based on congestion, bandwidth utilization, content, etc. For example, if traffic congestion increases, scheduling for all or a number of subscriber terminals may be transferred to a scheduler that handles congested traffic, for example, a demand-based scheduler (e.g., a DAMA scheduler). Alternatively, if traffic decreases, the scheduler used may be a speculative scheduler (e.g., an EMSS scheduler). Furthermore, a hybrid demand/predictive scheduler may also be used.

Embodiments described herein provide a balance between opposing scheduler designs. Customers with lots of credit card transactions, for example, may use a DAMA type of scheduler (if a user-specified responsiveness requirement can be met by DAMA) because the traffic is random and infrequent. As another example, FTP traffic may be sent to a periodic scheduler. In some embodiments, statistics at the headend (subscriber terminal), such as how often the user generates requests in random channel, etc., may be used to aid the bandwidth grant decision.

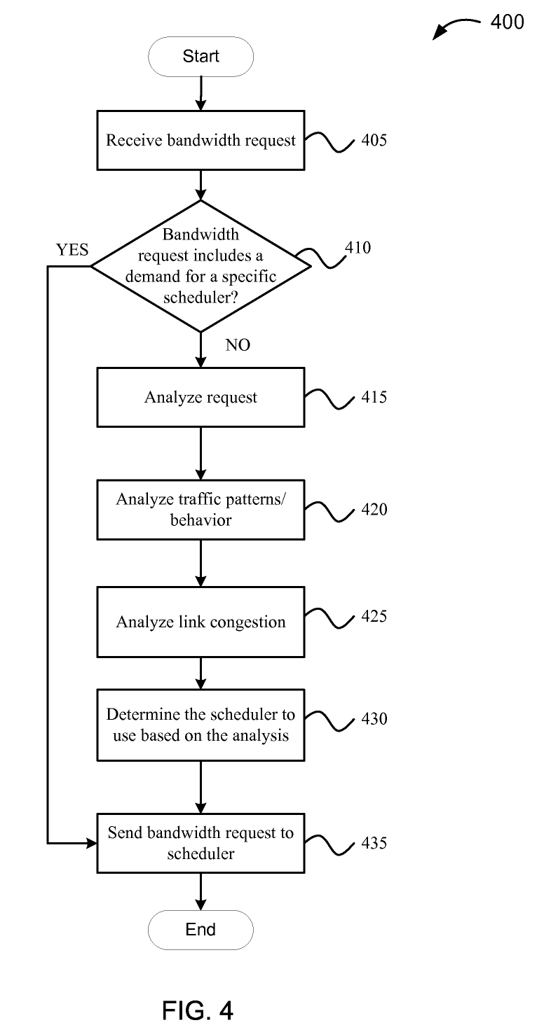

FIG. 4 shows a flowchart of a method for choosing a scheduler based on a bandwidth request and/or on network traffic at an allocator according to one embodiment. A bandwidth request is received from a client or clients at block 405. Furthermore, the bandwidth request, in some embodiments, may be a request from a subscriber terminal or a request from a scheduler or any other server or component of the satellite system. The allocator may then determine whether a demand for a specific scheduler has been requested at decision block 410. If so, in some embodiments, the allocator sends the bandwidth request to the demanded scheduler at block 435. In other embodiments, the allocator may override the requested scheduler. The request may be analyzed at block 415 for data type, ip address, etc. to determine the best scheduler equipped to handle the bandwidth request. The network traffic and patterns of the client may be analyzed at block 420 to determine the scheduler best equipped to handle the request.

At block 425, the congestion levels and/or bandwidth utilization of the link may be analyzed to further determine the scheduler best suited to handle the request. Based at least in part on the analysis performed in blocks 415, 420, and 425, the allocator may look up which scheduler is best equipped to most efficiently handle and schedule the bandwidth request (block 430). The allocator, at block 435, may then send the bandwidth request to the scheduler as determined in block 430. In some embodiments, the bandwidth request may alternatively be sent to a default scheduler.

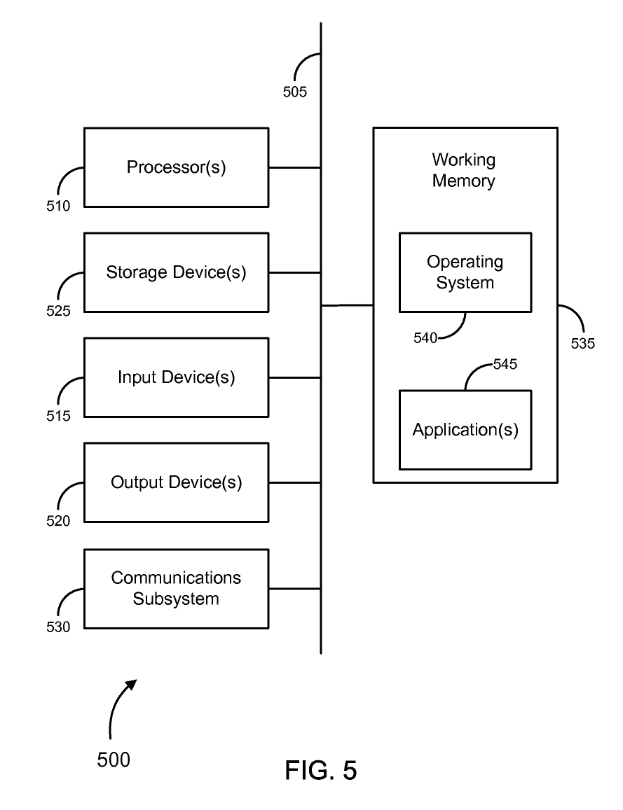

FIG. 5 provides a schematic illustration of one embodiment of a computer system 500 that can perform the methods of the invention. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505 (or may otherwise be in communication, as appropriate). The hardware elements can include one or more processors 510, including without limitation one or more general-purpose processors and/or one or more special-purpose processors (such as digital signal processing chips, graphics acceleration chips, and/or the like); one or more input devices 515, which can include without limitation a mouse, a keyboard and/or the like; and one or more output devices 520, which can include without limitation a display device, a printer and/or the like.

The computer system 500 may further include (and/or be in communication with) one or more storage devices 525, which can comprise, without limitation, local and/or network accessible storage and/or can include, without limitation, a disk drive, a drive array, an optical storage device, a solid-state storage device such as a random access memory (“RAM”) and/or a read-only memory (“ROM”), which can be programmable, flash-updateable and/or the like. The computer system 500 might also include a communications subsystem 530, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 530 may permit data to be exchanged with a network (such as the network described below, to name one example), and/or any other devices described herein. In many embodiments, the computer system 500 will further comprise a working memory 535, which can include a RAM or ROM device, as described above.

The computer system 500 also can comprise software elements, shown as being currently located within the working memory 535, including an operating system 540 and/or other code, such as one or more application programs 545, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer-readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 500) to perform methods of the invention. According to a set of embodiments, some or all of the procedures of such methods are performed by the computer system 500 in response to processor 510 executing one or more sequences of one or more instructions (which might be incorporated into the operating system 540 and/or other code, such as an application program 545) contained in the working memory 535. Such instructions may be read into the working memory 535 from another machine-readable medium, such as one or more of the storage device(s) 525. Merely by way of example, execution of the sequences of instructions contained in the working memory 535 might cause the processor(s) 510 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 500, various machine-readable media might be involved in providing instructions/code to processor(s) 510 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media includes, for example, optical or magnetic disks, such as the storage device(s) 525. Volatile media includes, without limitation, dynamic memory, such as the working memory 535. Transmission media includes coaxial cables, copper wire and fiber optics, including the wires that comprise the bus 505, as well as the various components of the communications subsystem 530 (and/or the media by which the communications subsystem 530 provides communication with other devices). Hence, transmission media can also take the form of waves (including without limitation, radio, acoustic and/or light waves, such as those generated during radio-wave and infra-red data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc., carried by the signals) to the working memory 535, from which the processor(s) 505 retrieves and executes the instructions. The instructions received by the working memory 535 may optionally be stored on a storage device 525 either before or after execution by the processor(s) 510.

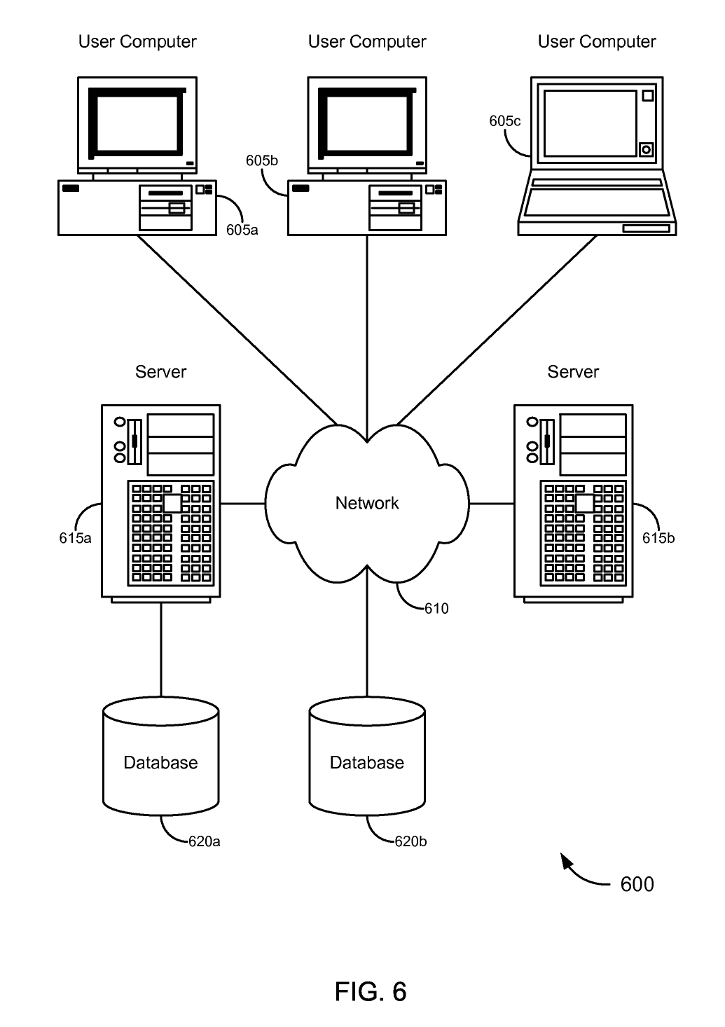

A set of embodiments comprises systems for implementing dedicated shared byte caches. Merely by way of example, FIG. 6 illustrates a schematic diagram of a system 600 that can be used in accordance with one set of embodiments. The system 600 can include one or more user computers 605. The user computers 605 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially available UNIX™ or UNIX-like operating systems. These user computers 605 can also have any of a variety of applications, including one or more applications configured to perform methods of the invention, as well as one or more office applications, database client and/or server applications, and web browser applications. Alternatively, the user computers 605 can be any other electronic device, such as a thin-client computer, Internet-enabled mobile telephone, and/or personal digital assistant (PDA), capable of communicating via a network (e.g., the network 610 described below) and/or displaying and navigating web pages or other types of electronic documents. Although the exemplary system 600 is shown with three user computers 605, any number of user computers can be supported.

Certain embodiments of the invention operate in a networked environment, which can include a network 610. The network 610 can be any type of network familiar to those skilled in the art that can support data communications using any of a variety of commercially available protocols, including without limitation TCP/IP, SNA, IPX, AppleTalk, and the like. Merely by way of example, the network 610 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 615. Each of the server computers 615 may be configured with an operating system, including without limitation any of those discussed above, as well as any commercially (or freely) available server operating systems. Each of the servers 615 may also be running one or more applications, which can be configured to provide services to one or more clients user computers 605 and/or other servers 615.

Merely by way of example, one of the servers 615 may be a web server, which can be used, merely by way of example, to process requests for web pages or other electronic documents from user computers 605. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 605 to perform methods of the invention.

The server computers 615, in some embodiments, might include one or more application servers, which can include one or more applications accessible by a client running on one or more of the client computers 605 and/or other servers 615. Merely by way of example, the server(s) 615 can be one or more general purpose computers capable of executing programs or scripts in response to the user computers 605 and/or other servers 615, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configurator, database clients, API clients, web browsers, etc.) running on a user computer 605 and/or another server 615. In some embodiments, an application server can create web pages dynamically for displaying the information in accordance with embodiments of the invention. Data provided by an application server may be formatted as web pages (comprising HTML, Javascript, etc., for example) and/or may be forwarded to a user computer 605 via a web server (as described above, for example). Similarly, a web server might receive web page requests and/or input data from a user computer 605 and/or forward the web page requests and/or input data to an application server. In some cases a web server may be integrated with an application server.

In accordance with further embodiments, one or more servers 615 can function as a file server and/or can include one or more of the files (e.g., application code, data files, etc.) necessary to implement methods of the invention incorporated by an application running on a user computer 605 and/or another server 615. Alternatively, as those skilled in the art will appreciate, a file server can include all necessary files, allowing such an application to be invoked remotely by a user computer 605 and/or server 615. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620. The location of the database(s) 620 is discretionary: merely by way of example, a database 620a might reside on a storage medium local to (and/or resident in) a server 615a (and/or a user computer 605). Alternatively, a database 620b can be remote from any or all of the computers 605, 615, so long as the database can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 620 can be a relational database, that is adapted to store, update, and retrieve data in response to SQL-formatted commands. The database might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configurator. Similarly, while various functionalities are ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method of implementing a traffic and/or congestion-based upstream scheduler over a satellite link, the method comprising:
receiving, at an access point, a bandwidth request from a client, wherein the bandwidth request includes an associated application type;
analyzing, at a scheduler allocator within the access point, the application type to determine which of a plurality of schedulers is best equipped to efficiently service the bandwidth request based on the application type;
analyzing, at the scheduler allocator, network traffic patterns of the client to determine which of the plurality of schedulers is best equipped to efficiently service the bandwidth request based on the network traffic patterns of the client;
analyzing, at the scheduler allocator, congestion of the satellite link to determine which of the plurality of schedulers is best equipped to efficiently service the bandwidth request based on the congestion of the satellite link;
based on the analysis of the application type, the network traffic patterns of the client, and the congestion of the satellite link, selecting, at the scheduler allocator, one of the plurality of schedulers; and
sending the bandwidth request to the selected scheduler.

2. A method of implementing a traffic and/or congestion-based upstream scheduler over a satellite link, as in claim 1, wherein a first scheduler from the plurality of schedulers comprises a demand-based scheduler.

3. A method of implementing a traffic and/or congestion-based upstream scheduler over a satellite link, as in claim 2, wherein the demand-based scheduler comprises a demand-assigned multiple access (DAMA) scheduler.

4. A method of implementing a traffic and/or congestion-based upstream scheduler over a satellite link, as in claim 2, wherein a second scheduler from the plurality of schedulers comprises a predictive scheduler.

5. A method of implementing a traffic and/or congestion-based upstream scheduler over a satellite link, as in claim 4, wherein the predictive scheduler comprises an Enhanced Mobile Satellite Services (EMSS) scheduler.

6. A method of implementing a traffic and/or congestion-based upstream scheduler over a satellite link, as in claim 1, wherein the access point comprises a Satellite Modem Termination System (SMTS).

7. A method of implementing a traffic and/or congestion-based upstream scheduler over a satellite link, as in claim 1, wherein the access point comprises a gateway.

8. A method of implementing a traffic and/or congestion-based upstream scheduler over a satellite link, as in claim 1, further comprising determining that, based on the associated application type, the bandwidth request includes a demand from a specific scheduler.

9. A method of implementing a traffic and/or congestion-based upstream scheduler over a satellite link, as in claim 8, further comprising sending the bandwidth request to the specific scheduler.

10. A method of implementing a traffic and/or congestion-based upstream scheduler over a satellite link, as in claim 1, wherein the application type comprises one or more of the following: voice over IP (VOIP), HTTP, FTP, UDP, and VPN.

11. A method of implementing a traffic and/or congestion-based upstream scheduler over a satellite link, as in claim 1, wherein the network traffic patterns of the client comprise historical data which includes one or more of the following: an average amount of time between each bandwidth request, an average size of bandwidth requests, and URL access history.

12. A method of implementing a traffic and/or congestion-based upstream scheduler over a satellite link, as in claim 1, wherein the congestion of the satellite link comprises one or more of the following: a total number of active clients utilizing the satellite link, a total amount of bandwidth being used of the satellite link, and a total amount of bandwidth allocated to the clients on the satellite link.

13. A system for implementing a traffic and/or congestion-based upstream scheduler over a satellite link, the system comprising:
a client configured to transmit a bandwidth request;
a satellite in communication with the client; and
an access point including a scheduler allocator and a plurality of schedulers, the access point in communication with the client via the satellite, the access point configured to receive the bandwidth request from the client, wherein the bandwidth request includes an associated application type,
the scheduler allocator configured to analyze the application type to determine which of a plurality of schedulers is best equipped to efficiently service the bandwidth request based on the application type, analyzing network traffic patterns of the client to determine which of the plurality of schedulers is best equipped to efficiently service the bandwidth request based on the network traffic patterns of the client, analyzing congestion of the satellite link to determine which of the plurality of schedulers is best equipped to efficiently service the bandwidth request based on the congestion of the satellite link, based on the analysis of the application type, the network traffic patterns of the client, and the congestion of the satellite link, select one of the plurality of schedulers, and send the bandwidth request to the selected scheduler.

14. A system for implementing a traffic and/or congestion-based upstream scheduler over a satellite link as in claim 13, further comprising a subscriber terminal coupled with the client and the satellite.

15. A system for implementing a traffic and/or congestion-based upstream scheduler over a satellite link as in claim 13, wherein the access point comprises a gateway.

16. A machine-readable medium for implementing a traffic and/or congestion-based upstream scheduler over a satellite link, having sets of instructions which, when executed by a machine, cause the machine to:
receive, at an access point a bandwidth request from a client, wherein the bandwidth request includes an associated application type;
analyze, at a scheduler allocator within the access point, the application type to determine which of a plurality of schedulers is best equipped to efficiently service the bandwidth request based on the application type;
analyze, at the scheduler allocator, network traffic patterns of the client to determine which of the plurality of schedulers is best equipped to efficiently service the bandwidth request based on the network traffic patterns of the client;
analyze, at the scheduler allocator, congestion of the satellite link to determine which of the plurality of schedulers is best equipped to efficiently service the bandwidth request based on the congestion of the satellite link;
based on the analysis of the application type, the network traffic patterns of the client, and the congestion of the satellite link, select, at the scheduler allocator, one of the plurality of schedulers; and
send the bandwidth request to the selected scheduler.

17. A machine-readable medium for implementing a traffic and/or congestion-based upstream scheduler over a satellite link as in claim 16, having sets of instructions which, when executed by the machine, further cause the machine to determine that, based on the associated application type, the bandwidth request includes a demand from a specific scheduler.

18. A machine-readable medium for implementing a traffic and/or congestion-based upstream scheduler over a satellite link as in claim 17, having sets of instructions which, when executed by the machine, further cause the machine to send the bandwidth request to the specific scheduler.
